(19) United States
(12) Patent Application Publication
(10) Pub. No.: US 2012/0014319 A1
(43) Pub. Date: Jan. 19, 2012

(54) GSM controlled wireless mesh system

(76) Inventors: Baohong Sun, Ottawa (CA); Shiquan Wu, Ottawa (CA)

(21) Appl. No.: 13/067,939

(22) Filed: Jul. 8, 2011

Related U.S. Application Data
(60) Provisional application No. 61/344,396, filed on Jul. 13, 2010.

(51) Int. Cl. H04W 84/10

(52) U.S. Cl. 370/328

(57) ABSTRACT

This invention discloses a GSM controlled mesh wireless system, apparatus and data routing method which can facilitate the low latency, high reliability and security enabled data transmission system. Unlike prior arts, the invented system make use of AP reported information, centrally determine the transmission path based on service requirements, and control the AP configuration change in real or near real time through in band 802.11 messages or WAN air interface, e.g. GSM messages. Those APs not participating in the transmission route will be optionally turned off or transmission power reduced.

### CLAIM OF PRIORITY

This patent application claims the benefit of priority from U.S. Provisional Patent Application No. U.S. 61/344,396 filed on Jul. 13, 2010. This application incorporates by reference the entire disclosure of U.S.A. Provisional Patent Application No. U.S. 61/344,396.

### 1. FIELD OF THE INVENTION

This invention discloses a GSM controlled wireless mesh system, apparatus and data routing approach which can facilitate the low latency, high reliability and security enabled data transmission system.

### 2. BACKGROUND OF THE INVENTION

There are wirelesses applications need to transmit sensor data or video images to a destination. These wireless applications can only tolerate certain amount of latency, jitter and need high reliability, high security transmission.

Conventional cellular wireless network has base stations and terminals. Each terminal usually associate to one base station (BTS) or one sector of BTS through standard air interface. This BTS or a sector of a BTS usually named a serving cell. Each base station is deployed in a pre-selected spot and covers a pre-planned area to form a cellular network. All Base stations have been connected to a base station controller (BSC) or a radio network controller (RNC) by backhaul transmission network which can be either wired links such as fiber, T1/E1 or via microwave links. A BSC or an RNC can manage a group of base stations. The BSC or RNC is connected to core network.

For terminal-1 to communicate with terminal-2, terminal-1 will random access the serving cell to exchange the management information, and a connection to the core network will be setup. Through the core network, the terminal-2 will be paged and the connection will be setup. For the fixed network topology and connections, the latency, jitter and data routing are pretty constant.

There is another wireless network in practice, the so called wireless mesh network, which is formed by multiple wireless transceivers a.k.a Access Points (AP). The wireless Access Points are deployed to form a mesh topology, therefore each access point can communicate with its neighboring access points. A mesh network usually consists of Access Points, gateways, and terminals or clients. Most of the access points designed today have routing capabilities. When terminal wants to send a data packet to another, it sends the data to its associated AP first; this AP may forward the data packet to another AP according to some rules or a routing protocol. The data packet may hop many APs to reach its destination. There are more than 70 mesh routing protocols have been developed, such as OSPF (open shortest path first), OLSR (optimized link state routing) and DSR (dynamic source routing) etc. refer to http://en.wikipedia.org/wiki/Wireless_mesh_network.

Several standardized wireless transceivers can be used to form a wireless mesh Access Points, include IEEE 802.11 technologies a.k.a WiFi, IEEE 802.15.4 a.k.a Zigbee and IEEE 802.16/WiMax.

GSM is the abbreviation for Global System for Mobile Communications. GSM is an international wireless communication standard for digital wireless communication. It's one of the most popular wireless communication standards and has the most subscribers and covers most of populated areas in the world.

GSM is a system designed for voice and low data communication. GSM system has a well defined GSM frame structure to enable the orderly information passage. The GSM frame structure establishes schedules for the predetermined use of timeslots. By establishing these schedules through the use of a frame structure, GSM terminal and GSM base station can communicate voice, data and signaling information with various types of data intermixed. GSM terminal and GSM base station know exactly what types of information are being transmitted.

GSM frame structure provides the basis for various physical channels used within GSM, and accordingly it is soul of the overall system.

The basic GSM frame lasts for approximately 4.615 ms (i.e. 120/26 ms) and it forms the basic unit for the definition of logical channels. Each basic frame is further divided into 8 time slots, as illustrated in FIG. 2. The time slot duration is 0.577 ms (15/26 ms), which could be shared by different users within the GSM system. The slots for transmission and reception for a given GSM terminal are offset 3 time slots so that the terminal does not have to transmit and receive at the same time.

The basic GSM time frame defines the structure upon which all the timing and structure of the GSM messaging and signaling are encoded in time order.

In brief, GSM base station transmits two types of channel, namely the traffic channel and the control channel. Accordingly the channel structures are organized into two different types of frames, one as traffic frame, and the other as control frame.

The foregoing objects and advantages of the invention are illustrative that can be achieved by various exemplary embodiments and are not intended to be exhaustive or to limit the possible advantages which can be realized. Thus, these and other objects and advantages of the various exemplary embodiments will be apparent from the description herein or can be learned from practicing the various exemplary embodiments, both as embodied herein or as modified in view of any variation that may be apparent or equivalent to those persons skilled in the art.

Code Division Multiple Access (CDMA) is another popular technology in practice. CDMA employs spread-spectrum technology and a special coding scheme (where each transmitter is assigned a code) to allow multiple users to be multiplexed over the same physical channel. Commercialized standards include IS-95, CDMA 2000, WCDMA/UMTS etc.

### 3. SUMMARY OF THE INVENTION

This invention discloses a GSM controlled mesh wireless system, apparatus and data routing approach which can facilitate the low latency, high reliability and security enabled data transmission system. Different from conventional mesh routing protocols, the invented system makes use of AP reported information, centrally determine the data transmission route based on service requirements, and control the AP configuration in real or near real time through in band 802.11 messages or WAN air interface, e.g. GSM messages. Those APs not involved in routing may be turned off or their transmission power gets reduced.

Various exemplary embodiments are illustrated in the following. Some simplifications and omissions are made to highlight some aspects of the exemplary embodiments which will not limit the scope of the invention.

The proposed system comprises: 1) An array of Access Points, 2) a Mesh Topology Controller (MTC), 3) terminals or clients.

The Access Point comprises a GSM transceiver module and 802.11 transceiver module/modules. The GSM transceiver is responsible for communication with GSM network. Preferably, WiFi transceiver's timing is synchronized with GSM frame timing.

The Mesh Topology Controller (MTC) is the soul of this invention. Through in band 802.11 messages or WAN (wide area network) air interface, e.g. GSM messages, MTC can change the Access Point configurations in real time or near real time, to setup the data transmission route, and turn off the radios not involved or reduce some APs transmission power.

The Mesh Topology Controller (MTC) keeps a database of the current mesh network topology, individual AP information comprised real and non real time information, e.g. antenna height, antenna down tilt, geo-location, channel bandwidth, channel coding schemes, modulation schemes, working channel number, receiving RSSI, co-channel interference level, link status to neighbor APs, working frequency, working band, radio transmission power, top 6 neighborhood AP-SSIDs with stronger signal strength, AP traffic load, associated terminals and clients, etc.

The terminal is capable of 802.11 protocols.

When a terminal has a data packet to deliver, it communicates its service request to its associated AP. AP forwards the request to MTC via GSM link.

Upon the request received, MTC will look into service requirements, and perform a decision algorithm to decide the best possible route/routes and calculate the best possible APs.

MTC will simultaneously determine if to turn off the radio or lower down the transmission power of the non selected APs.

Through the in band 802.11 messages or through WAN air interface, e.g. GSM messages, the Mesh Topology Controller will control in real and near real time the AP configuration and radio link relationship matrix change, to setup the expected data transmission path.

### 4. DESCRIPTION OF DRAWINGS

The present invention will be further understood from the following detailed description and reference drawings.

FIG. 1 Illustrates a GSM/GPRS cellular network

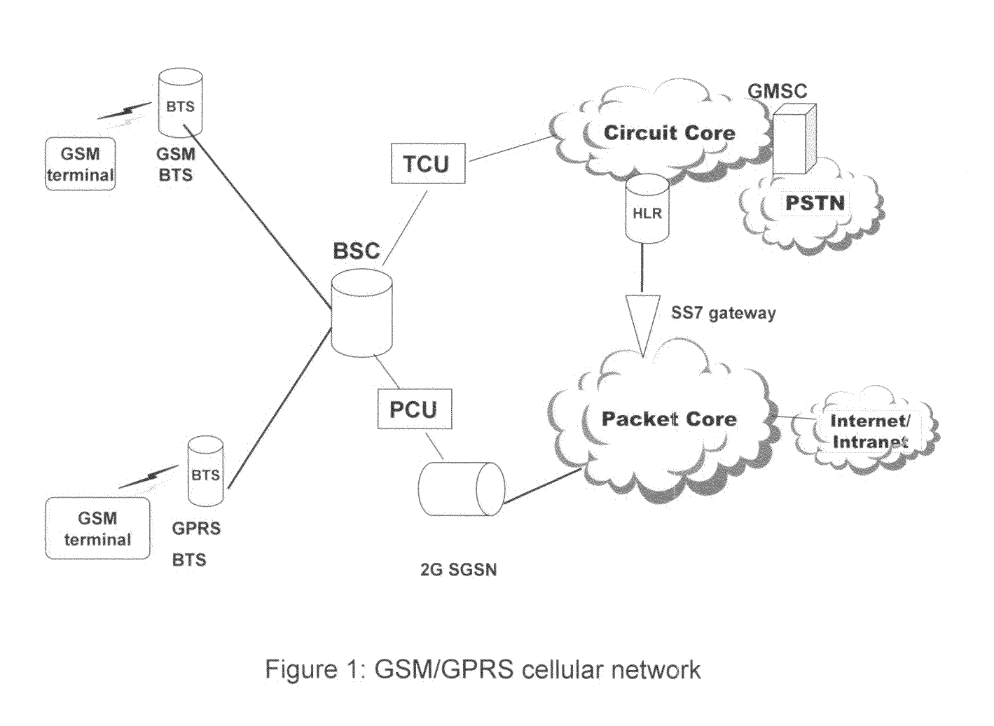

FIG. 2 Describes a conventional WiFi mesh network

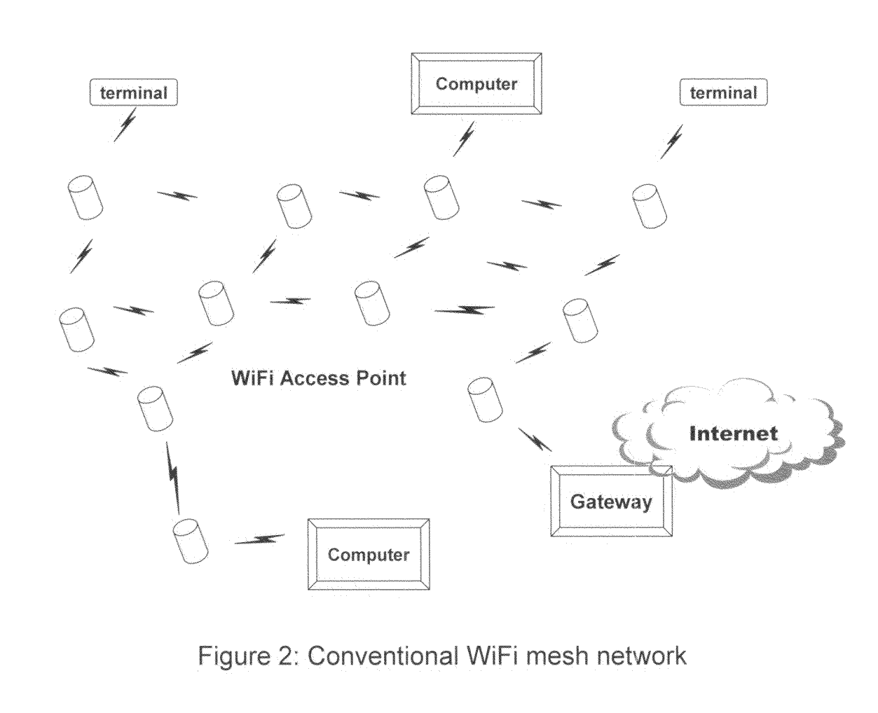

FIG. 3 Basic GSM frame structure

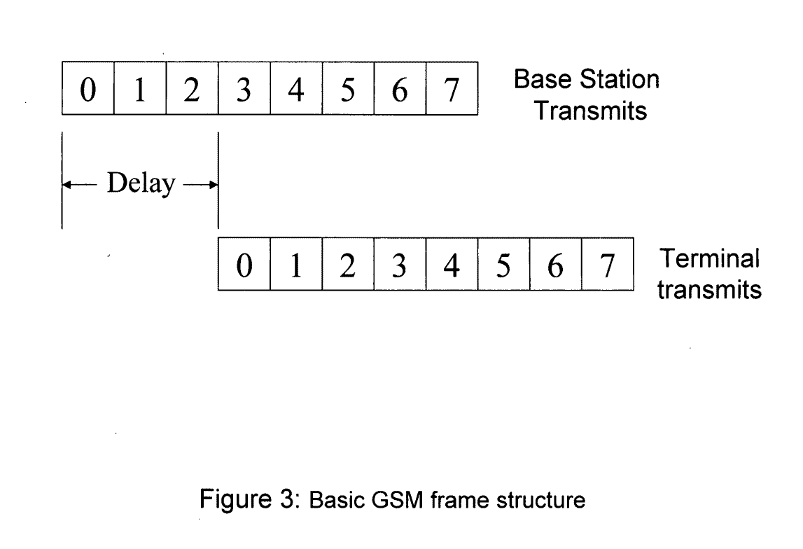

FIG. 4 GSM multi-frame, Super-frame and Hyper frame

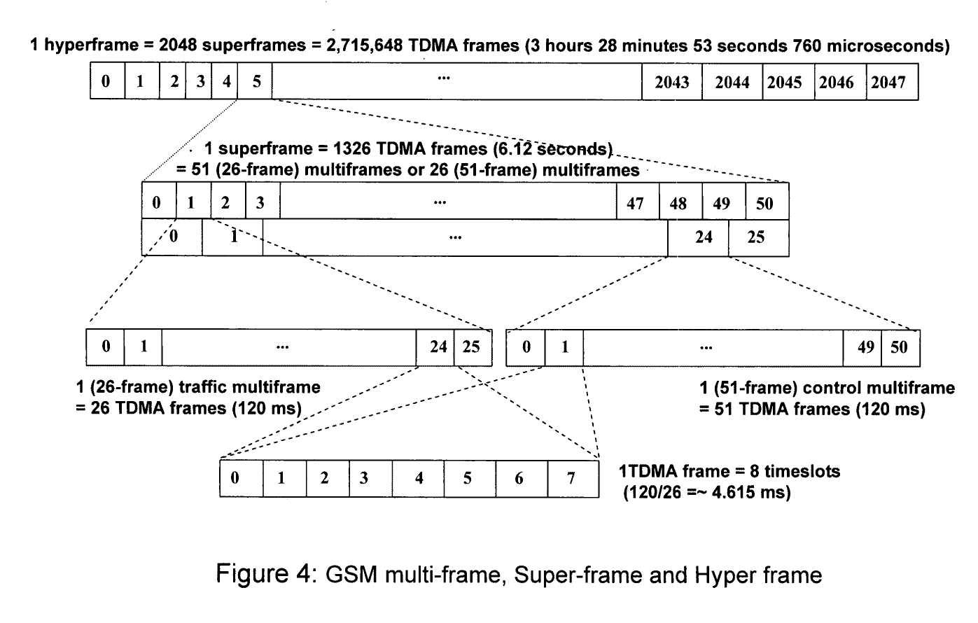

FIG. 5 GSM controlled wireless mesh system

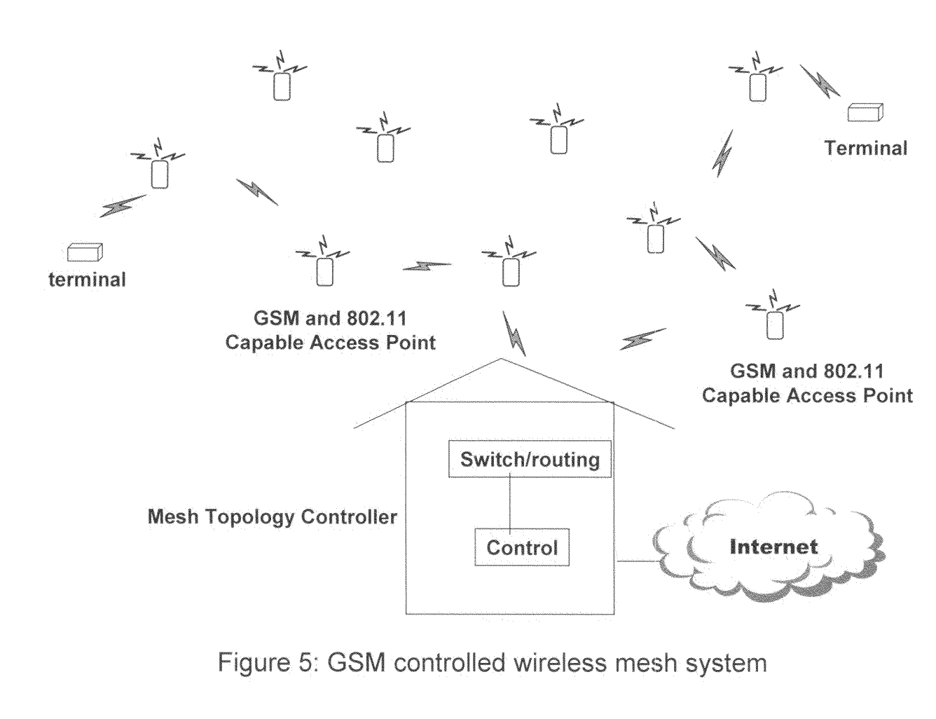

### 5. DETAILED DESCRIPTION OF THE INVENTION

Various exemplary embodiments are summarized as the following. Certain simplifications and omissions are made intends to highlight and introduce some aspects of the exemplary embodiments which will not limit the scope of the invention. Detailed descriptions of a preferred exemplary embodiment are adequate to those having skills in the art to make and to use the inventive system concepts and methods.

The proposed GSM controlled mesh wireless system, apparatus and data routing approach comprises: 1) an array of Access Points; 2) A Mesh Topology Controller (MTC); 3) 802.11 capable Terminals. The Mesh Topology Controller controls the AP configuration scheme and radio link relationship matrix change in real time or near real time, through in band 802.11 messages or through WAN air interface, e.g. GSM messages.

The Access Points are capable of both 802.11 and GSM air interfaces. Therefore, the access point can behave as an 802.11 AP or a GSM terminal.

The MTC is capable of GSM air interface, 802.11 air interface, CPU processor and memory storage. MTC communicates with each access point through scheduled procedures or through polling.

Each access point will regularly report its status such as the channel bandwidth, channel coding scheme, modulation scheme, working channel number, receiving RSSI, co-channel interference level, link status to neighbor APs, working frequency, working band, radio transmission power, top 6 neighborhood AP SSID of higher signal strength, traffic load, associated terminals and clients, etc.

Subject to service latency requirement, MTC will schedule a transmission path and calculate the APs to form a route to fulfill the service latency requirements.

Subject to service reliability requirement, MTC will schedule a transmission path and compute the APs to form a route to minimize the packet loss probability.

Subject to service bandwidth requirement, MTC will schedule a transmission path and select the APs to form a route to fulfill the bandwidth requirement.

Subject to service security requirement, MTC will schedule a transmission path and pick the APs to form a secure route or diversity routes to securely deliver the packets.

We claim:

1. A GSM controlled mesh wireless system comprising: 1) an array of Access Points; 2) A Mesh Topology Controller (MTC); 3) 802.11 capable Terminals.

2. The Access Point, as claimed in claim 1, comprises GSM and 802.11 transceivers, are capable of PHY and MAC but not IP routing capabilities. The Access Points follow commands passing through in band 802.11 or WAN au interface such as GSM, Hi real time or near real time to 1) turn on/off its radio transmission, 2) change its radio transmission power, 3) change its channel bandwidth, 4) change its channel coding scheme, 5) change its modulation scheme, 6) change its working channel number, 7) change its working frequency, 8) change its working band, 9) disassociate specific terminals and clients, etc.

3. The Access Point, as claimed in claim 1, will periodically report to MTC its status through in band 802.11 messages or WAN air interface, e.g. GSM messages. The status information comprises 1) geo-location, 2) channel bandwidth, 3) channel coding scheme, 4) modulation scheme, 5) working channel number, 6) receiving RSSI, 7) co-channel interference level, 8) link status to neighbor APs, 9) working frequency, 10) working band, 11) radio transmission power, 12) top 6 strong signal neighbor AP SSID, 13) traffic load, 14) associated terminals and clients, etc.

4. The Mesh Topology Controller, as claimed in claim 1, makes use of in band 802.11 messages or WAN air interface, e.g. GSM messages, to control 1) AP configuration change, 2) radio link relationship matrix change. The AP configuration comprises 1) channel bandwidth, 2) channel coding scheme, 3) modulation scheme, 4) working channel number, 6) working frequency, 7) working band, 8) radio transmission power, 9) associated terminals and clients, etc.

5. The Mesh Topology Controller (MTC), as claimed in claim 1, keeps a database of AP relationship matrix, individual AP static and dynamic configuration information comprise 1) antenna height, 2) antenna down tilt, 3) geo-location, 4) channel bandwidth, 5) channel coding scheme, 6) modulation scheme, 7) working channel number, 8) receiving RSSI, 9) co-channel interference level, 10) link status to neighbor APs, 11) working frequency, 12) working band, 13) radio transmission power, 14) top 6 strong signal neighbor AP SSID, 15) AP traffic load, 16) associated terminals and clients, etc.

6. The Mesh Topology Controller, as claimed in claim 1, contains a decision module, basing on aforementioned AP configuration and relationship matrix data base information, schedule a shortest latency transmission path and select the associated APs, and instruct the associated APs to make the configuration changes accordingly to setup the path in real or near real time. Optionally, MTC can choose to turn off the non-involved APs or to reduce their transmission power.

7. The Mesh Topology Controller, as claimed in claim 1, contains a decision module, basing on aforementioned AP configuration and relationship matrix data base information, the decision module will calculate a route having less interference and instruct the selected APs to make the change accordingly to form the transmission path in real or near real time. MTC may turn off the APs that are not selected in the route or reduce their transmission power.

8. The Mesh Topology Controller, as claimed in claim 1, contains a decision module, basing on aforementioned AP configuration and relationship matrix data base information, adapt to the high order modulation, high transmission power capable APs to form a transmission path, and instruct the participated APs to make the change accordingly to setup the path in real or near real time. Optionally, MTC may turn off APs not involved or reduce their transmission power.

9. The Mesh Topology Controller, as claimed in claim 1, contains a decision module, basing on aforementioned AP configuration and relationship matrix data base information, select the encryption capable APs to form a transmission path, and instruct the related APs to make the change accordingly to setup the path in real or near real time.

10. The Mesh Topology Controller as claimed in claim 1 comprises a communication module that can poll or push the spectrum usage information from internet or to internet.
